(19) United States
(12) Patent Application Publication
(10) Pub. No.: US 2019/0138242 A1
(43) Pub. Date: May 9, 2019

(54) LOCK-FREE ASYNCHRONOUS BUFFER

(71) Applicant: RAYTHEON COMPANY, Waltham, MA (US)

(72) Inventors: Lloyd J. Lewins, Waltham, MA (US); Jeremy Edwards, Waltham, MA (US)

(73) Assignee: RAYTHEON COMPANY, Waltham, MA (US)

(21) Appl. No.: 15/806,902

(22) Filed: Nov. 8, 2017

(51) Int. Cl. G06F 3/06; G06F 9/52; G06F 5/12

(52) U.S. Cl. CPC G06F 3/0656; G06F 9/526; G06F 2209/521; G06F 2205/123; G06F 5/12

(57) ABSTRACT

A system for sharing data between two processes implements a memory arranged as a two dimensional ping/pong buffer where a writing operation alternately swaps buffers in one dimension and a reading operation swaps buffers in the other dimension. Accordingly, writing is into one or the other of a reading buffer set not currently being read with each write alternating between the write buffers. Data is retrieved from the buffer that is not currently being written. The buffer switching is coordinated by using commonly accessed variables between the reader and the writer and implements a system that is lock-free.

### BACKGROUND

In order for a system to respond to events or inputs in “real-time” it must have execution times on the order of milliseconds, if not faster. Thus, portions of a real-time system must have access to data immediately and cannot spend processing cycles “idling” or waiting for data to become available. Often, a producer (or writer) is producing (writing) data and a consumer (or reader) is consuming (reading), i.e., operating on, this data in these real-time system. The consumer may not need all the data produced—it just needs to get the “latest” or most current data. In order to meet performance goals, however, neither the producer nor the consumer should be “blocked” or kept waiting for the other (or any other task) to complete before gaining access.

Most often, the gaining of access to data that has been written involves accessing memory in a computing environment. Known solutions include using a classic circular memory buffer. There are disadvantages to this approach as it requires the consumer to read and discard multiple items to get to the latest, i.e., the most relevant, data. This approach incurs a not insignificant performance hit. Further, the buffer must be sufficiently deep to allow the writer to always have room to write and this assumes the reader and writer run at a same fixed rate and not where one is significantly faster (or slower) than the other.

Another approach uses a semaphore or other mutual exclusion (mutex) construct. This method introduces latency necessary to obtain lock and does not allow for simultaneous access—which can also incur a performance hit.

What is needed, therefore, is a system that provides for a consumer to have access to data and a writer to write the data without incurring waiting penalties on real-time performance.

### SUMMARY

Embodiments of the present disclosure are directed to a system and method for sharing data between processes such that reading and writing operations occur asynchronously and without blocking. Advantageously, data can be read from one portion of buffer memory while being written to a different portion of buffer memory.

In one aspect of the present disclosure, a method of accessing a memory device is implemented in a computer. The computer comprises a processor and a tangible computer-readable medium storing a plurality of instructions executable by the processor to implement the method. The method of memory device accessing comprises: defining a plurality of memory buffers in the memory device, each memory buffer identified by MemBuff(X, Y) where each of X and Y is only either a first value or a second value, where the first value is not the same as the second value; maintaining a current pingPong variable PP_{C} configured to flip between the first value and the second value; and maintaining a current Index I_{C}=(X_{C}, Y_{C}) where each of X_{C} and Y_{C} is configured to flip between the first value and the second value. Data is written to the memory device by: retrieving the current pingPong variable PP_{C} and current Index variable I_{C}=(X_{C}, Y_{C}); writing data to a memory buffer MemBuff(X_{C}, PP_{C}); and when writing to the memory buffer MemBuff(X_{C}, PP_{C}) is complete: flipping the X_{C} value in the Index I_{C} to the other of the first value or the second value and setting Y_{C}=PP_{C}.

Further, reading from the memory comprises: retrieving the pingPong variable PP_{C} and Index I_{C}=(X_{C}, Y_{C}); setting a temp variable Wₜₑₘₚ to a flipped value of X_{C}; reading data located at a memory buffer MemBuff(Wₜₑₘₚ, PP_{C}); and when reading from the memory buffer MemBuff(Wₜₑₘₚ, PP_{C}) is complete, flipping the pingPong variable PPC to the other of the first value or the second value.

In another aspect of the present disclosure, a tangible computer-readable medium includes instructions for execution by a computer system to implement the methods above.

### BRIEF DESCRIPTION OF THE DRAWINGS

Various aspects of at least one embodiment of the present disclosure are discussed below with reference to the accompanying figures. It will be appreciated that for simplicity and clarity of illustration, elements shown in the drawings have not necessarily been drawn accurately or to scale. For example, the dimensions of some of the elements may be exaggerated relative to other elements for clarity or several physical components may be included in one functional block or element. Further, where considered appropriate, reference numerals may be repeated among the drawings to indicate corresponding or analogous elements. For purposes of clarity, not every component may be labeled in every drawing. The figures are provided for the purposes of illustration and explanation and are not intended as a definition of the limits of the disclosure. In the figures:

FIG. 1 is a block diagram of an embodiment of the present disclosure;

FIG. 2 is block diagram of a buffer memory in accordance with an embodiment of the present disclosure;

FIG. 3 is a state diagram of operation of a method in accordance with an embodiment of the present disclosure;

FIG. 4 is a block diagram of a system in accordance with one embodiment of the present disclosure;

FIG. 5 is a memory write method in accordance with an embodiment of the present disclosure; and

FIG. 6 is a memory read method in accordance with an embodiment of the present disclosure.

### DETAILED DESCRIPTION

In the following detailed description, numerous specific details are set forth in order to provide a thorough understanding of the embodiments of the present disclosure. It will be understood by those of ordinary skill in the art that these embodiments of the present disclosure may be practiced without some of these specific details. In other instances, well-known methods, procedures, components and structures may not have been described in detail so as not to obscure the embodiments of the present disclosure.

Prior to explaining at least one embodiment of the present disclosure in detail, it is to be understood that the disclosure is not limited in its application to the details of construction and the arrangement of the components set forth in the following description or illustrated in the drawings. Also, it is to be understood that the phraseology and terminology employed herein are for the purpose of description only and should not be regarded as limiting.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

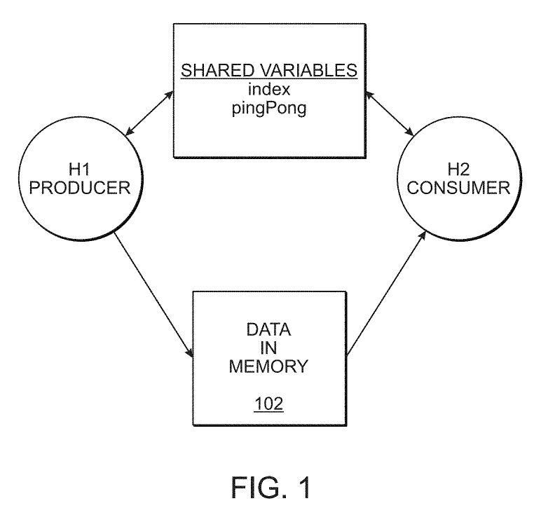

Referring now to FIG. 1, embodiments of the present disclosure implement a method of interacting with a memory by sharing data in, for example, a memory 102 between a producer of the data H1 and a consumer of the data H2. The producer H1 and the consumer H2 may be, but are not limited to, processes running on separate computers, separate threads or processes running in a same or different computers or separate devices. Further, the computers and/or threads may be implemented in one or more virtual machines.

In operation, the producer H1 is producing data that the consumer H2 is using, however, the consumer H2 may not have a need for all the data produced. The consumer H2 may only need the “latest” data, with respect to when the consumer H2 proceeds to retrieve data.

As will be described in more detail below, conceptually, the memory 102 is arranged as a two dimensional ping/pong buffer where the writing operation alternately swaps buffers in one dimension and the reading operation swaps buffers in the other dimension.

Accordingly, the producer H1 writes into either read-ping or read-pong buffer set, but each write alternates between the write Ping-Pong buffers. When new data is produced by H1, the consumer H2 switches the read ping-pong buffer before reading but reads from the one of the write ping-pong buffers that is not currently being written. The consumer H2 reads the last read buffer when no new data is produced by H1.

The buffer switching is coordinated by using commonly accessed variables, pingPong and index, described below in more detail, and advantageously implement a system that is lock-free, wait-free bounded as there is no need for a mutual exclusion (mutex) function. Accordingly, reads and writes are fast and deterministic as there is no complex synchronization, interrupt locking or searching/scanning. The size of the buffer is fixed and small, i.e., only four times the size of one data element, where the data element size is whatever amount of memory is needed.

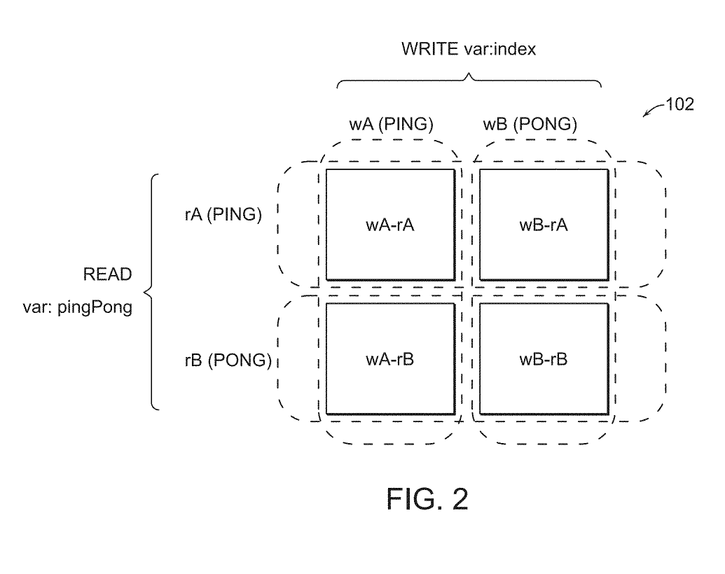

Referring now to FIG. 2, the memory 102 is conceptually arranged as a 2x2 array of buffers of the same size. These buffers could be arranged in one contiguous range within a memory, e.g., RAM, however, one of ordinary skill in the art understands that there are other memory configurations that could be implemented. When writing, the producer H1 toggles, i.e., alternates, between “write” ping-pong (wA and wB) buffers, i.e., the “columns,” on every write—but writes into the currently unused “read” ping-pong (rA or rB) row.

The consumer H2 toggles, i.e., alternates, between the “read” ping-pong (rA and rB) buffers, i.e., the “rows”, if the writer has written since the last read. If this occurs, the consumer H2 reads from the write ping-pong (wA or wB) column that is not currently being written, i.e., is now reading from the most recently completely written data.

Advantageously, by operating in this manner, the buffer being read by the consumer H2 will never be simultaneously written to by the producer H1.

Two shared variables are used for synchronization:
pingPong−written by the consumer H2 indicating the buffer (rA or rB) it is not reading; and
index=(wW, rR)−written by the producer H1 indicating a tuple of the write-column buffer opposite it last completely wrote to (wA or wB) and the read-row (rA or rB) the pingPong variable was currently set to at the time of writing. Alternately, the index variable could be represented as index=(X, Y) where X and Y each is one of only different two values, e.g., (A or B) or (0 or 1) or the like.

These shared variables represent the “current” values as will be better understood below. Of course, the naming convention of these variables is arbitrary and merely used for explanatory purposes.

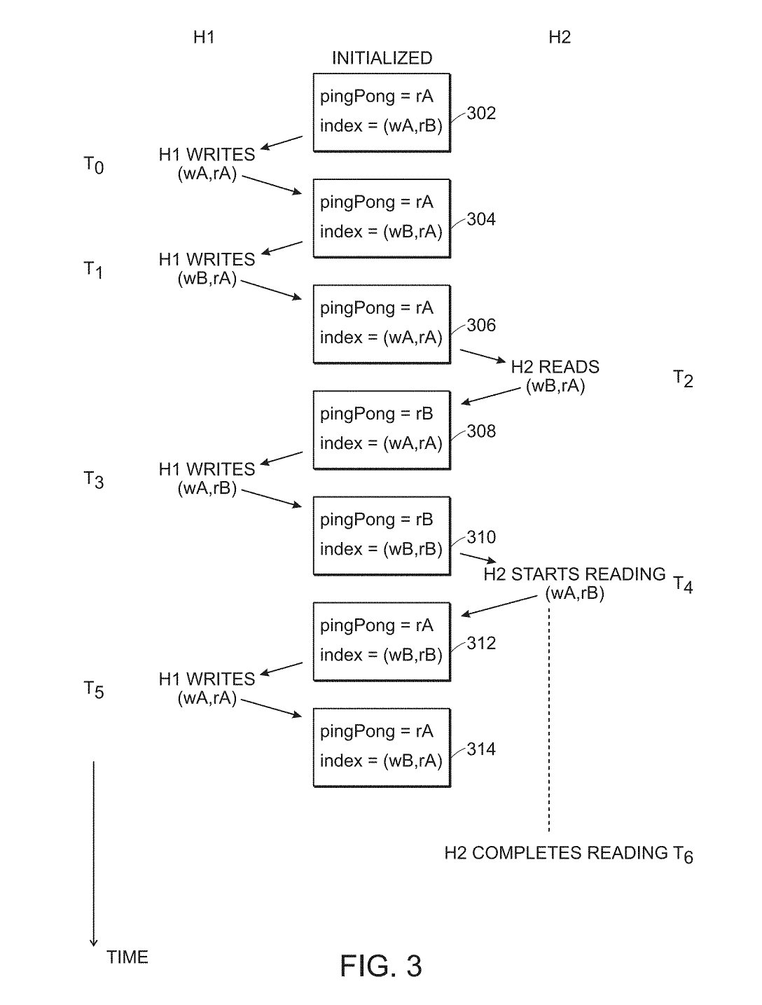

An example of operation, referring to FIG. 3, will now be presented.

An initial state of the variables 302 is arbitrarily set such that pingPong=rA and index=(wA, rB). At some time T0, the producer H1 writes to the buffer (wA, rA) by taking the value rA from the pingPong variable and the value wA from the index variable. When writing is complete, the producer H1 then “ping-pongs” or “flips” the write-column buffer value and now the index=(wB, rA), that is, the write column changes from wA to wB. The state of the variables 304 is pingPong=rA and index=(wB, rA).

Next, at time T1, the producer H1 writes again, retrieving the current state of the variables 304 where pingPong=rA and index=(wB, rA) and writing to buffer (wB, rA) by taking the value rA from the pingPong variable and the value wB from the index variable. Once the write operation is completed, the producer H1 then “ping-pongs” the write-column buffer value and now index=(wA, rA). The variable state 306 is set such that pingPong=rA and index=(wA, rA). The states of the variables 302, 304, 306 have only changed with respect to the write value as only write operations, to this point in time, have occurred and the producer H1 only modifies the value of the write column value of the index variable.

At time T2, the consumer H2 initiates a read operation and retrieves the current state of the variables 306 where pingPong=rA and index=(wA, rA). The consumer H2 compares read-row buffers from pingPong and index and sets, i.e., flips, pingPong=rB in the variable state 308. The consumer H2 is now reading in read-row rA and the write-column wB, which is the “opposite” of the value retrieved from the index variable. In other words, because the index variable in state 306 indicates the write column that will be written to next, the write column that should be read from is the opposite of that value, i.e., the “flipped” or “other” value as there are only two values that it could be. Note that H2 does not change the index variable and, as understood by one of ordinary skill in the art, could use a temporary value for the column to read from. The consumer H2 thus commences reading the buffer(wB, rA), as above at time T₁, as it is the most recently completely written buffer and, therefore, contains the most recent data.

At time T3, the producer H1 initiates a write operation using the variable state 308 where pingPong=rB and index=(wA, rA). The producer H1 completes writing buffer(wA, rB) and ping-pongs the write-column value and sets the index=(wB, rB). To write in the (wA, rB) buffer and set index=(wB, rB) as the current setting of pingPong=rB indicates that the consumer H2 is next reading from the rA row of buffers. It should be noted that the system does not need to consider whether the consumer H2 is still reading as the protocol assures that writing cannot occur where reading may be continuing.

When the producer H1 completes the write operation, the state of the variables 310 is pingPong=rB and index=(wB, rB).

As an example of reading and writing occurring at the same time without interfering or corrupting data, at time T4, the consumer H2 initiates a reading operation based on the variable state 310 where pingPong=rB and index=(wB, rB). Accordingly, at the beginning of the read operation, the consumer H2 updates to the variable state 312 such that pingPong=rA and index=(wB, rB) (unchanged) indicating that reading is taking place in the rB row of buffers as determined by the read-row value retrieved from the index variable. In this case the reading is taking place in buffer (wA, rB).

In this example, during the read operation of consumer H2 begun at time T4, and prior to its completion at time T6, the producer H1 starts a write operation at time T5 based on the variable state 312 where pingPong=rA and index=(wB, rB). Accordingly, per the foregoing, the producer H1 will not write in buffer read-row rB and writes, instead, in the buffer(wA, rA). Once the write is completed, the variable state 314 is updated to reflect pingPong=rA and index=(wB, rA) (unchanged).

In this example, the read operation that started at time T4 does not complete until time T6, after the producer H1 has written “new” data. Advantageously, the producer H1 was not stopped from writing the data while the consumer H2 was reading and vice-versa. Depending on the data requirements, the consumer H2 will be able to retrieve the data when next necessary per its operation.

The use of a two-dimensional array of ping-pong buffers (one dimension for reading, one dimension for writing) allows both functions to occur simultaneously as access to the data structure does not require locks and results in increased performance as neither the producer nor the consumer is blocked waiting for the other (or any other task).

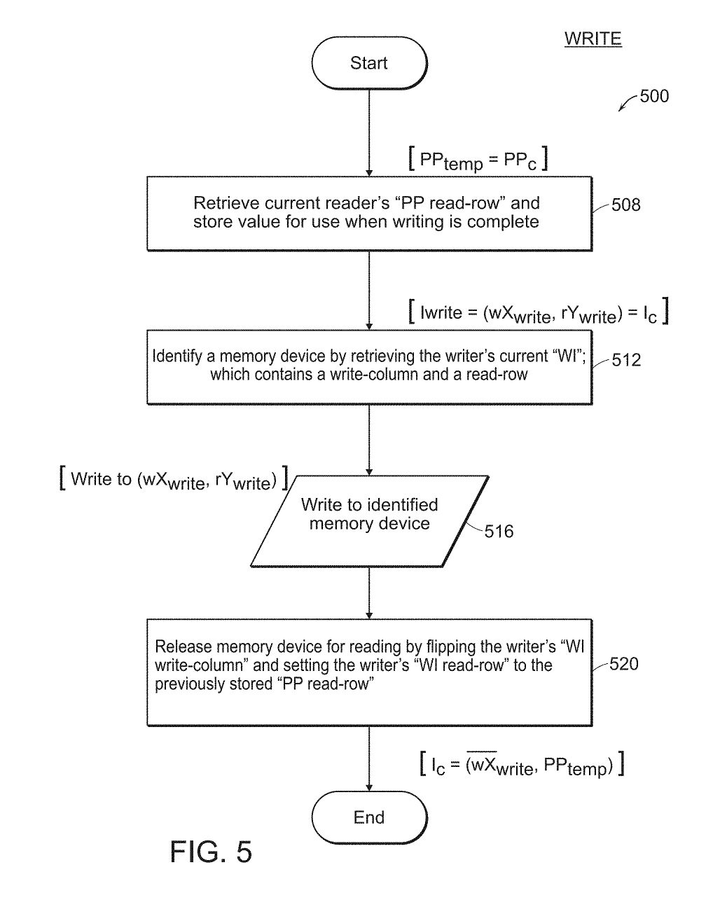

Referring now to FIG. 5, in another approach to explaining the writing operation of embodiments of the present disclosure, a method 500 of writing to a memory begins at step 508 where a current reader's “PP read-row” value is retrieved and stored for use when writing is complete, [PPₜₑₘₚ=PP_{c}]. At step 512, a memory device is identified by retrieving the writer's current “WI” value which contains a write-column and a read-row indication, [I_{wire}=(wX_{write}, rY_{write})=I_{c}]. Subsequently, step 516, data is written to the identified memory device, [Write to (wX_{write}, rY_{write})]. Afterwards, step 520, the recently written to memory device is released for reading by flipping the writer's “WI write-column” value and setting the writer's “WI read-row” value to the previously stored “PP read-row” value, [I_{C}=(wX_{write}, PPₜₑₘₚ)].

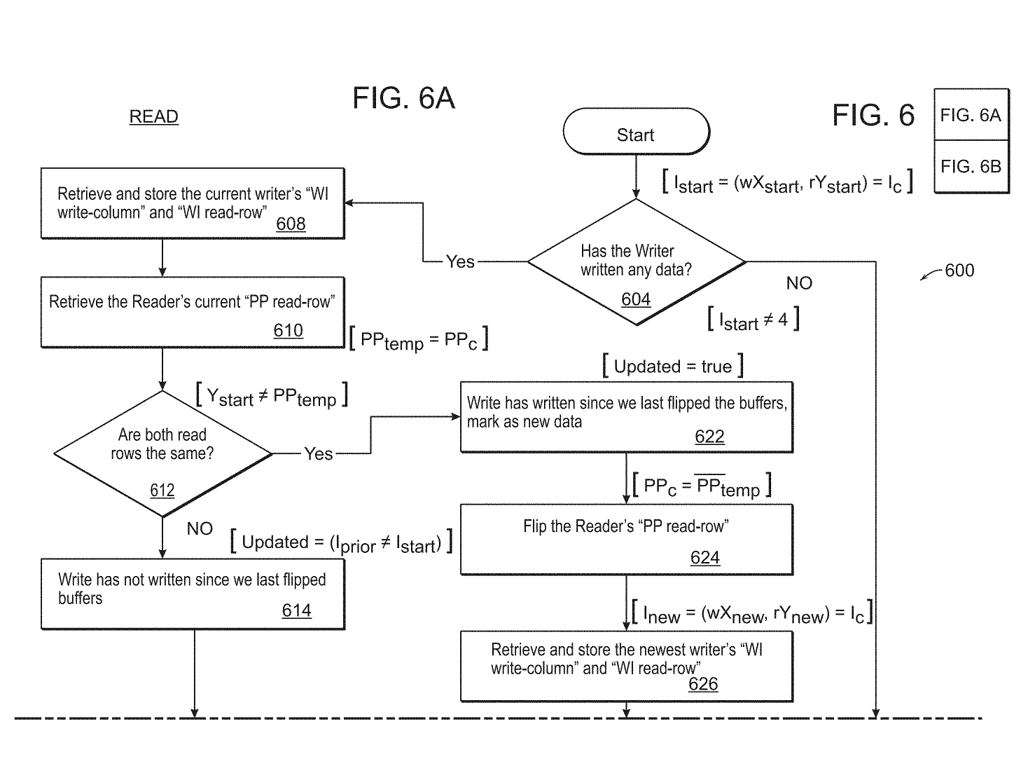

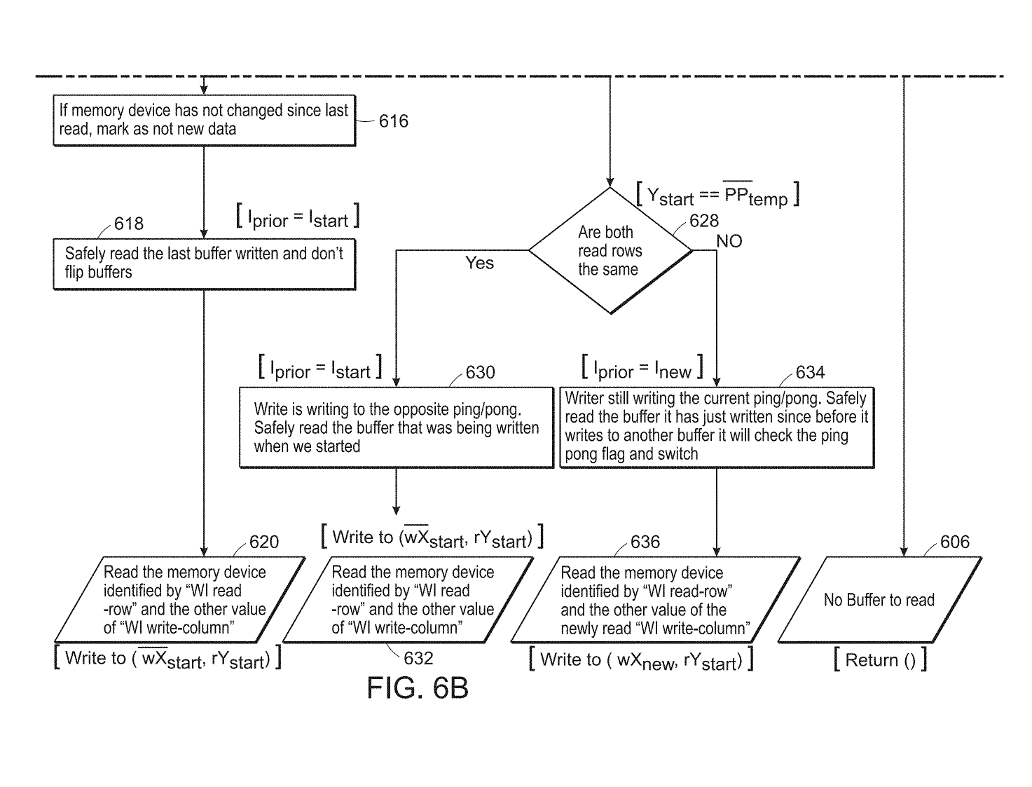

Further, another approach to explaining the reading operation of embodiments of the present disclosure references FIG. 6, where a method 600 determines, step 604, whether or not the writer has written any data, [Istart≠4], where four (4) is the number of buffers in one example. If not, control passes to step 606 where it is determined that there is no buffer to read as there is no new data, [Return ( )].

If it is determined at step 604 that the writer has written new data, control passes to step 608 where the reader retrieves and stores the current writer's “WI write-column” and “WI read-row” values and next, step 610, retrieves the reader's current “PP read-row” value, [PPₜₑₘₚ=PP_{c}].

At step 612, it is determined if both read rows are the same, [Yₛₜₐᵣₜ≠PPₜₑₘₚ]. If not, control passes to step 614 indicating that the writer has not written since last flipped buffers and if memory device has not changed since last read, mark as not new data, step 616, [Updated=(Iₚᵣᵢₒᵣ≠Iₛₜₐᵣₜ)]. The reader can then safely read the last buffer written and doesn't need to flip the buffers, step 618, [(Iₚᵣᵢₒᵣ=Iₛₜₐᵣₜ)]. At step 620, the reader reads the memory device identified by the “WI read-row” value and the other value of “WI write-column,” [Write to (w̅X̅ₛₜₐᵣₜ, rYₛₜₐᵣₜ)].

Returning to step 612, if both read rows are the same, [Updated=true], control passes to step 622 indicating the writer has written since the system last flipped buffers and it is marked as there being new data. The reader's “PP read-row” value is flipped, step 624, [PP3_{c}=P̅P̅ₜₑₘₚ], and subsequently, step 626, the system retrieves and stores the newest writer's “WI write-column” and WI read-row” values, [I_{new}=(wX_{new}, rY_{new})=I_{c}].

At step 628 it is determined if both read row values are the same, [Yₛₜₐᵣₜ==P̅P̅ₜₑₘₚ]. If so, control passes to step 630, [Iₚᵣᵢₒᵣ=Iₛₜₐᵣₜ], and the writer is now set for writing to the opposite ping/pong value and the system can safely read the buffer that was being written to at step 632 by reading the memory device identified by the “WI read-row” value and the other value of “WI write-column,” [Write to w̅X̅ₛₜₐᵣₜ, rYₛₜₐᵣₜ].

Returning to step 628, if the read row values are not the same, control passes to step 634 indicating that the writer is still writing the current ping/pong value, [Iₚᵣᵢₒᵣ=I_{new}]. The system can safely read the buffer it has just written since before it writes to another buffer it will check the ping-pong flag and switch, which is executed at step 636 by reading the memory device identified by the “WI read-row” value and the other value of the newly read “WI write-column,” [Write to (wX_{new}, rYₛₜₐᵣₜ)].

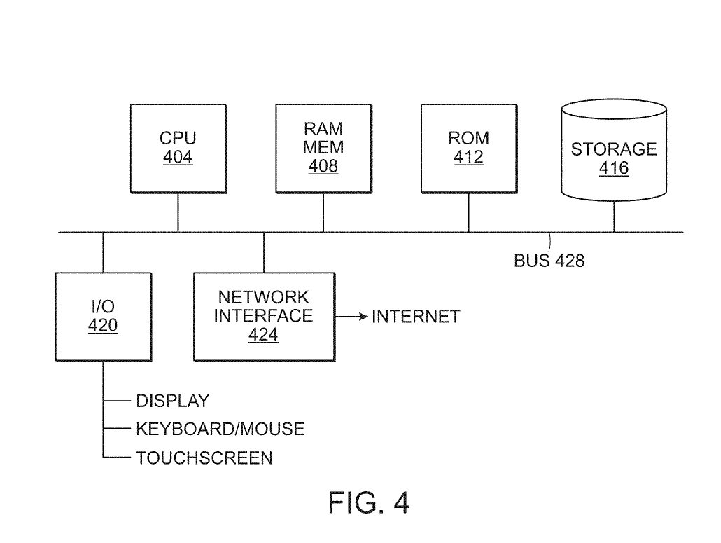

Either of the producer H1 and the consumer H2, referring to FIG. 4, may comprise a CPU 404, RAM 408, ROM 412, a mass storage device 416, for example, a disk drive, an I/O interface 420 to couple to, for example, display, keyboard/mouse or touchscreen, or the like and a network interface module 424 to connect to, either wirelessly or via a wired connection, to the Internet. All of these modules are in communication with each other through a bus 428. The CPU 404 executes an operating system to operate and communicate with these various components.

While the pair of the producer H1 and consumer H2 has been described above as writing and reading, respectively, from the memory, it is within the scope of this disclosure that a program, thread, etc., could be both a producer and a consumer. While the embodiment described herein operates in producer/consumer pairs another embodiment could include a series of interleaved pairs where a consumer in one pair is a producer in a next and vice-versa. Of course, each pair would have its own respective set(s) of memory buffers as arranged and described herein.

Various embodiments of the above-described systems and methods may be implemented in digital electronic circuitry, in computer hardware, firmware, and/or software. The implementation can be as a computer program product, i.e., a computer program embodied in a tangible information carrier. The implementation can, for example, be in a machine-readable storage device to control the operation of data processing apparatus. The implementation can, for example, be a programmable processor, a computer and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

While the above-described embodiments generally depict a computer implemented system employing at least one processor executing program steps out of at least one memory to obtain the functions herein described, it should be recognized that the presently described methods may be implemented via the use of software, firmware or alternatively, implemented as a dedicated hardware solution such as in a field programmable gate array (FPGA) or an application specific integrated circuit (ASIC) or via any other custom hardware implementation.

It is to be understood that the present disclosure has been described using non-limiting detailed descriptions of embodiments thereof that are provided by way of example only and are not intended to limit the scope of the disclosure. Features and/or steps described with respect to one embodiment may be used with other embodiments and not all embodiments of the disclosure have all of the features and/or steps shown in a particular figure or described with respect to one of the embodiments. Variations of embodiments described will occur to persons of skill in the art.

It should be noted that some of the above described embodiments include structure, acts or details of structures and acts that may not be essential to the disclosure and which are described as examples. Structure and/or acts described herein are replaceable by equivalents that perform the same function, even if the structure or acts are different, as known in the art, e.g., the use of multiple dedicated devices to carry out at least some of the functions described as being carried out by the processor of the present disclosure. Therefore, the scope of the disclosure is limited only by the elements and limitations as used in the claims.

Whereas many alterations and modifications of the disclosure will no doubt become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

1. A method, implemented in a computer, of accessing a memory device, the computer comprising a processor and a tangible computer-readable medium storing a plurality of instructions executable by the processor to implement the method, the method comprising:
defining a plurality of memory buffers in the memory device, each memory buffer identified by MemBuff(X, Y) where each of X and Y is only either a first value or a different second value;
maintaining a current pingPong variable PP_{C} configured to flip between the first value and the second value;
maintaining a current Index I_{C}=(X_{C}, Y_{C}) where each of X_{C} and Y_{C} is configured to flip between the first value and the second value; and
writing data to the memory device by:
retrieving the current pingPong variable PP_{C} and current Index variable I_{C}=(X_{C}, Y_{C});
writing data to a memory buffer MemBuff(X_{C}, PP_{C}); and
when writing to the memory buffer MemBuff(X_{C}, PP_{C}) is complete:
flipping the X_{C} value in the Index I_{C} to the other of the first value or the second value and setting Y_{C}=PP_{C}.

2. The method of claim 1, further comprising:
retrieving the pingPong variable PP_{C} and Index I_{C}=(X_{C}, Y_{C});
setting a temp variable Wₜₑₘₚ to a flipped value of X_{C};
reading data located at a memory buffer MemBuff(W_{te mp}, PP_{C}); and
when reading from the memory buffer MemBuff(Wₜₑₘₚ, PP_{C}) is complete, flipping the pingPong variable PPC to the other of the first value or the second value.

3. The method of claim 1, further comprising defining the plurality of memory buffers as being arranged contiguously in the memory.

4. The method of claim 1, further comprising defining each memory buffer to have a same size.

5. The method of claim 1, wherein a first thread running in a first computer system is writing the data.

6. The method of claim 5, wherein a second thread running in a second computer system is reading the data.

7. The method of claim 6, wherein the first and second computer systems are separate from one another.

8. The method of claim 6, wherein the first and second computer systems are the same.

9. A tangible computer-readable medium storing instructions thereon that when executed within a computer system causes the computer system to implement a method of accessing a memory device, the method comprising:
defining a plurality of memory buffers in the memory device, each memory buffer identified by MemBuff(X, Y) where each of X and Y is only either a first value or a different second value;
maintaining a current pingPong variable PP_{C} configured to flip between the first value and the second value;
maintaining a current Index I_{C} =(X_{C}, Y_{C}) where each of X_{C} and Y_{C} is configured to flip between the first value and the second value; and
writing data to the memory device by:
retrieving the current pingPong variable PP_{C} and current Index variable I_{C}=(X_{C}, Y_{C});
writing data to a memory buffer MemBuff(X_{C}, PP_{C}); and
when writing to the memory buffer MemBuff(X_{C}, PP_{C}) is complete:
flipping the X_{C} value in the Index I_{C} to the other of the first value or the second value and setting Y_{C}=PP_{C}.

10. The computer-readable medium of claim 9, wherein the method further comprises:
retrieving the pingPong variable PP_{C} and Index I_{C}=(X_{C}, Y_{C});
setting a temp variable Wₜₑₘₚ to a flipped value of X_{C};
reading data located at a memory buffer MemBuff(Wₜₑₘₚ, PP_{C}); and
when reading from the memory buffer MemBuff(Wₜₑₘₚ, PP_{C}) is complete, flipping the pingPong variable PPC to the other of the first value or the second value.

11. The computer-readable medium of claim 9, wherein the method further comprises defining the plurality of memory buffers as being arranged contiguously in the memory.

12. The computer-readable medium of claim 9, wherein the method further comprises defining each memory buffer to have a same size.

13. The computer-readable medium of claim 9, wherein the method further comprises:
a first thread writing the data; and
a second thread reading the data.

14. A system comprising a processor and logic stored in non-transitory, computer-readable, tangible media in operable communication with the processor, the logic configured to store a plurality of instructions that, when executed by the processor, causes the processor to implement a method of accessing a memory device, the method comprising:
defining a plurality of memory buffers in the memory device, each memory buffer identified by MemBuff(X, Y) where each of X and Y is only either a first value or a different second value;
maintaining a current pingPong variable PP_{C} configured to flip between the first value and the second value;
maintaining a current Index I_{C} =(X_{C}, Y_{C}) where each of X_{C} and Y_{C} is configured to flip between the first value and the second value; and
writing data to the memory device by:
retrieving the current pingPong variable PP_{C} and current Index variable I_{C}=(X_{C}, Y_{C});
writing data to a memory buffer MemBuff(X_{C}, PP_{C}); and
when writing to the memory buffer MemBuff(X_{C}, PP_{C}) is complete:
flipping the X_{C} value in the Index I_{C} to the other of the first value or the second value and setting Y_{C}=PP_{C}.

15. The method of claim 14, further comprising:
retrieving the pingPong variable PP_{C} and Index I_{C}=(X_{C}, Y_{C});
setting a temp variable Wₜₑₘₚ to a flipped value of X_{C};
reading data located at a memory buffer MemBuff(Wₜₑₘₚ, PP_{C}); and
when reading from the memory buffer MemBuff(Wₜₑₘₚ, PP_{C}) is complete, flipping the pingPong variable PPC to the other of the first value or the second value.

16. The system of claim 14, the method further comprising defining the plurality of memory buffers as being arranged contiguously in the memory.

17. The system of claim 14, the method further comprising defining each memory buffer to have a same size.

18. The system of claim 14, wherein a first thread running in a first computer system is writing the data.

19. The system of claim 18, wherein a second thread running in a second computer system is reading the data.

20. The system of claim 19, wherein the first and second computer systems are separate from one another.
